(19) United States
(12) Patent Application Publication
(10) Pub. No.: US 2026/0203146 A1
(43) Pub. Date: Jul. 16, 2026

(54) OPTIMIZING FREQUENCY OF CLOUD SERVICE VALIDATION FOR ACTIVITIES IN INDUSTRIAL PROCESSES

(71) Applicant: INTERNATIONAL BUSINESS MACHINES CORPORATION, Armonk, NY (US)

(72) Inventors: Neil DELIMA, Scarborough (CA); Sarbajit Kumar RAKSHIT, Kolkata (IN); Tushar AGRAWAL, West Fargo, ND (US); Carolina GARCIA DELGADO, Zapopan (MX)

(21) Appl. No.: 19/024,095

(22) Filed: Jan. 16, 2025

(51) Int. Cl. G06F 9/54; G06F 9/455; G06Q 10/0633

(52) U.S. Cl. CPC G06F 9/547; G06F 9/45525; G06Q 10/0633

(57) ABSTRACT

A method, system, and computer program product configured to perform operations including: defining a workflow including a plurality of steps of an industrial process executed in an industrial environment; generating a digital twin of the industrial environment; identifying activities in the workflow that are candidates for cloud service validation by running simulations of different executions of the workflow in the industrial environment using the digital twin, wherein each of the activities includes one or more of the plurality of steps; determining confidence levels of cloud services configured to validate performance of the activities; and optimizing usage of the cloud services based on the confidence levels

### BACKGROUND

Aspects of the present invention relate generally to using cloud services to validate activities performed in an industrial process.

Industrial processes may include plural activities performed in a sequence. Cloud services may be used to validate the performance of an activity before proceeding to the next activity in the sequence.

### SUMMARY

In a first aspect of the invention, there is a method including: defining a workflow comprised of a plurality of steps of an industrial process executed in an industrial environment; generating a digital twin of the industrial environment; identifying activities in the workflow that are candidates for cloud service validation by running simulations of different executions of the workflow in the industrial environment using the digital twin, wherein each of the activities comprises one or more of the plurality of steps; determining confidence levels of cloud services configured to validate performance of the activities; and optimizing usage of the cloud services based on the confidence levels.

In another aspect of the invention, there is a computer program product comprising one or more computer-readable storage media and program instructions stored on the one or more computer-readable storage media to perform operations comprising: defining a workflow comprised of a plurality of steps of an industrial process executed in an industrial environment; generating a digital twin of the industrial environment; identifying activities in the workflow that are candidates for cloud service validation by running simulations of different executions of the workflow in the industrial environment using the digital twin, wherein each of the activities comprises one or more of the plurality of steps; determining confidence levels of cloud services configured to validate performance of the activities; and optimizing usage of the cloud services based on the confidence levels.

In another aspect of the invention, there is a computer system comprising a processor set, one or more computer-readable storage media, and program instructions stored on the one or more computer-readable storage media to cause the processor set to perform operations comprising: defining a workflow comprised of a plurality of steps of an industrial process executed in an industrial environment; generating a digital twin of the industrial environment; identifying activities in the workflow that are candidates for cloud service validation by running simulations of different executions of the workflow in the industrial environment using the digital twin, wherein each of the activities comprises one or more of the plurality of steps; determining confidence levels of cloud services configured to validate performance of the activities; and optimizing usage of the cloud services based on the confidence levels.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method in accordance with aspects of the present invention.

FIG. 4 shows a flowchart of an exemplary method in accordance with aspects of the present invention.

### DETAILED DESCRIPTION

Aspects of the present invention relate generally to using cloud services to validate activities performed in an industrial process. Implementations of the invention are directed to optimizing frequency of cloud service validation for activities in an industrial process.

Cloud services may be used to validate the performance of an activity in an industrial process before proceeding to the next activity in the industrial process. Such cloud services may receive data associated with the performance of the activity and return an output indicating whether the activity was performed correctly or incorrectly. This output may be used to make decisions about how to proceed with the industrial process, such as proceeding to a next activity or performing remedial action (e.g., rework) with respect to a previously completed activity. Using a cloud service to validate the completion of every activity in an industrial process can reduce the amount of rework involved in the industrial process since less rework may be required if a mistake is detected earlier in the industrial process rather than later in the industrial process. However, using cloud service validation after every step in an industrial process is costly and time consuming. For example, when a machine is being assembled, a digital twin cloud service may be called after every step of the assembly process to validate whether each step was preformed properly. Such frequent execution of cloud service (e.g., to validate every step in the industrial process) may reduce the amount of rework involved in the industrial process but comes at a cost of the time involved in calling the cloud service and the monetary price paid for using the cloud services.

Implementations of the invention provide an improvement in the technology of using cloud services to validate activities performed in an industrial process by optimizing a frequency of usage of such cloud services. Embodiments provide the improvement by: identifying activities in a workflow that are candidates for cloud service validation by running simulations of different executions of the workflow in the industrial environment using the digital twin; determining confidence levels of cloud services configured to validate performance of the activities; and optimizing usage of the cloud services based on the confidence levels. In embodiments, the optimization includes calling cloud services only for validating critical activities, and only when a confidence level of the cloud service is greater than a threshold. In this manner, implementations avoid calling cloud services to validate non-critical activities for which the cost or rework is low, and also avoid calling cloud services that have a low confidence level indicating that the output of the cloud service is not sufficiently reliable to justify paying for the cloud service. In this manner, implementations provide an improvement in this technology by reducing costs associated with utilizing cloud services to validate steps of the process.

Various embodiments provide the aforementioned improvement by providing a method for execution of cloud service, the method comprising: receiving a workflow comprised of a plurality of individual steps to be executed on an industrial floor; generating a digital twin of the industrial floor; simulating the execution of the workflow on the industrial floor using the digital twin; determining a confidence of a cloud service associated with each of the plurality of individual steps based on the simulations; and optimizing the usage of the cloud service associated with at least one or more of the plurality of individual steps.

In various embodiments, while performing an industrial process that is performed by executing a sequence of individual steps (e.g., an assembling operation, dismantling a structure etc.), and based on context of an activity in the industrial environment (e.g., degree of stability, level of precision of the activity, weather condition, etc.), a system performs a cost benefit analysis between execution of on one or more cloud services (e.g., digital twin simulation, execution of AI model, etc.) after completion of each step of the activity or after sets of steps are completed, so that the cloud services cost can be optimized for that activity. In embodiments, the system analyzes a confidence of the cloud service execution result and identifies at what frequency the one or more required cloud services should be executed to optimize cost for completing the activity. In embodiments, using edge computation, the system captures the sensor feeds associated with the activities in the industrial process, analyzes a predicted level of criticality after completion of each step, identifies next steps of an activity to be performed or any rework required, and determines whether to initiate usage of a cloud service upon completion of each activity. In embodiments, the system analyzes a workflow sequence of the industrial process and criticality of different steps in the workflow based on historical learning. Based on this, the system identifies steps in the workflow where cloud service validation should be used prior to proceeding to the next step.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as cloud service usage optimization code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

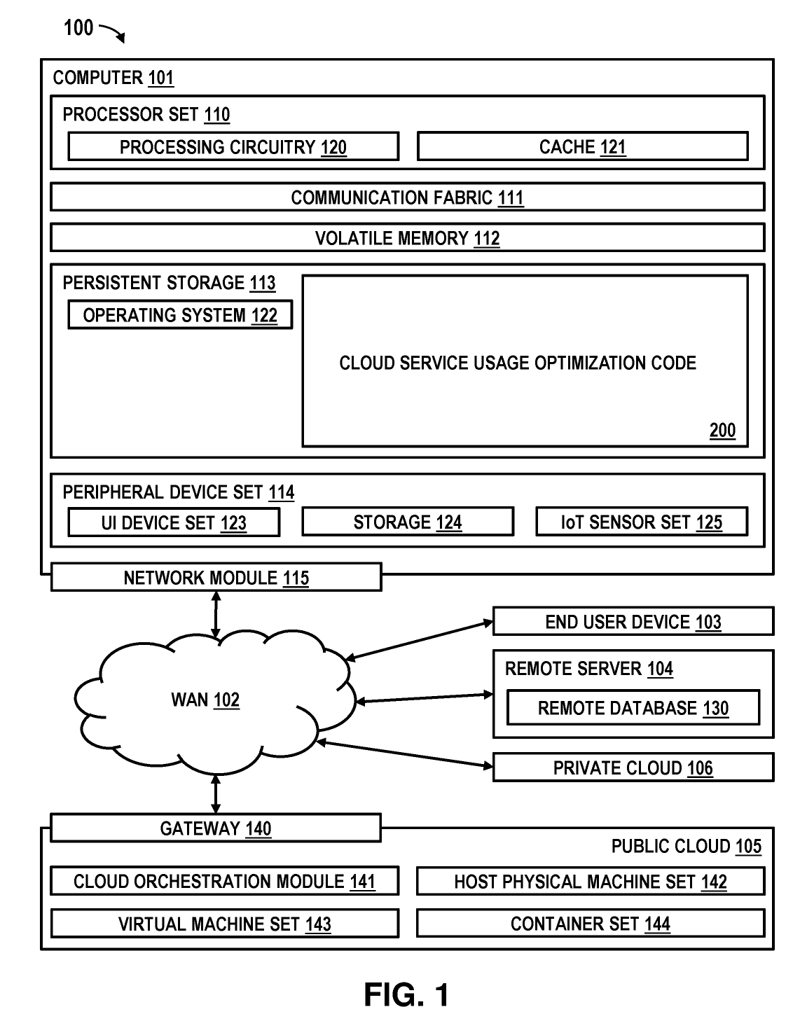

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

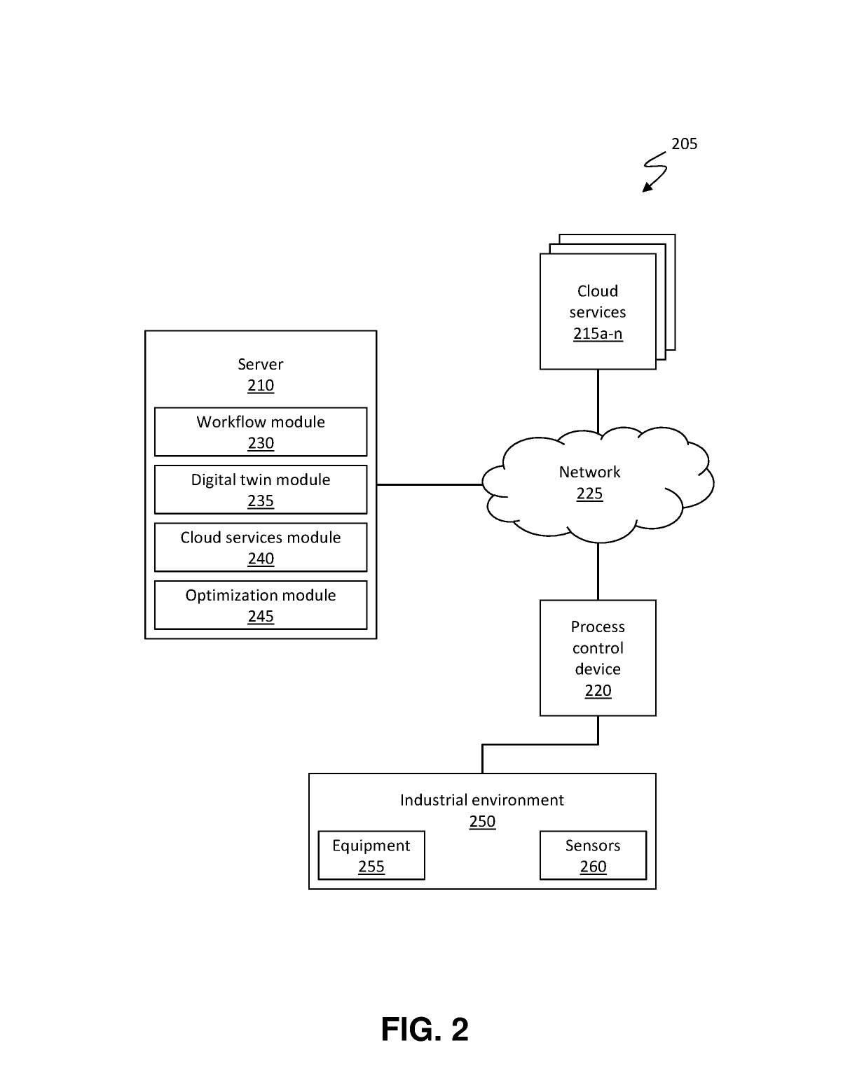

FIG. 2 shows a block diagram of an exemplary environment 205 in accordance with aspects of the invention. In embodiments, the environment 205 includes a server 210 that communicates with cloud services 215a-n and a process control device 220 via a network 225. In one example, the server 210 comprises a computing device such as one or more instances of the computer 101 of FIG. 1. In another example, the server 210 comprises one or more virtual machines, or one or more containers, running on one or more instances of the computer 101 of FIG. 1. In embodiments, the cloud services 215a-n comprise “n” number of different services that are provided via cloud computing such as SaaS. The services may include validation services that are configured to validate the performance of various activities in an industrial process, such as activities included in assembling or disassembling a physical machine or physical structure. Examples of such services include, but are not limited to, validating performance of an activity using a digital twin and/or an artificial intelligence (AI) model. In embodiments, the process control device 220 comprises one more instances of the EUD 103 of FIG. 1. In embodiments, the network 225 comprises one or more networks for communicating computer data, such as the WAN 102 of FIG. 1.

In embodiments, the server 210 of FIG. 2 comprises a workflow module 230, a digital twin module 235, a cloud services module 240, and an optimization module 245, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The server 210 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the invention, the workflow module 230 is configured to define a workflow comprised of a plurality of steps executed in an industrial environment 250. In embodiments, the workflow is a digital document that defines steps involved in an industrial process such as assembling or disassembling a physical machine (e.g., assembling an engine for use in a vehicle) or physical structure (e.g., building a bridge). In embodiments, defining the workflow comprises: identifying a process hierarchy of an industrial process (e.g., as designed in an industrial ecosystem) and collecting information around different steps to be performed in the processes in the process hierarchy; identifying specifications, capabilities, and roles of equipment 255 included in the industrial environment 250 and used to perform the steps in the processes in the process hierarchy; identifying integrations among the equipment 255; identifying connectivity of the equipment 255 within the industrial ecosystem (e.g., via sensors 260 in the industrial environment 250, such as sensors embedded in the surroundings, sensors attached to robots, sensors attached to the equipment, etc.); and analyzing the industrial process to create a sequence mapping of activities involved in the workflow, where activities include one or more of steps in the processes in the process hierarchy. The workflow module 230 may perform these operations based on one or more of: learning from historical data associated with other industrial processes performed in the industrial environment 250; manual setup via input from the process control device 220; and industrial crowdsourcing associated with other industrial processes performed in other industrial environments. The process control device 220 may communicate with various elements of the industrial environment 250, such as collecting data from the sensors 260 and providing control signals to the equipment 255.

In accordance with aspects of the invention, the digital twin module 235 is configured to generate a digital twin of the industrial environment 250. In embodiments, the digital twin is a virtual representation of the industrial environment 250 in which the workflow is performed, and the digital twin module 235 generates the digital twin based on information about the equipment 255 used to perform steps in the workflow. Generating the digital twin may include the digital twin module 235 collecting attributes of the equipment 255 and sensors 260 from the workflow and using this information to identify relationships between various ones of the equipment 255 and/or sensors 260 and how the various equipment performs steps in the workflow. Generating the digital twin may further include the digital twin module 235 collecting historic data associated with previously executed processes within the industrial environment 250 and using this historic data to further define the digital twin model.

In accordance with aspects of the invention, the digital twin module 235 is further configured to identify activities in the workflow that are candidates for cloud service validation by running simulations of different executions of the workflow in the industrial environment 250 using the digital twin. In embodiments, each of the activities comprises one or more of the plurality of steps of the workflow. In embodiments, the simulations include what-if scenarios that are run in the digital twin using different contextual conditions to determine the criticality of different ones of the steps in the workflow based on the different contextual conditions. Examples of contextual conditions that are varied in the simulations include but are not limited to: environmental temperature in the industrial environment; environmental pressure in the industrial environment; environmental humidity in the industrial environment; environmental wind speed and direction in the industrial environment; temperature, pressure, and/or mass flow rate (or volume flow rate) of a fluid used in the industrial environment; vibration of a part of the machine or structure in the industrial environment; deflection of a part of the machine or structure in the industrial environment; strain of a part of the machine or structure in the industrial environment; physical location and orientation of a part of the machine or structure in the industrial environment; and clearance (e.g., physical spacing) between two parts in the machine or structure in the industrial environment. In embodiments, the contextual conditions that are varied in the simulations are conditions that are measurable using sensors 260 in the industrial environment 250. In embodiments, running simulations of different executions of the workflow may be based at least in part on data from these sensors associated with current activities and historical data. In embodiment, the digital twin module 235 analyzes the results of the simulations to identify one or more activities that are critical to the workflow and deems these activities as candidates for validation via cloud services. In various embodiments, critical activities may be identified based on amount or cost of rework performed in the workflow if the activity is performed incorrectly. The simulations may involve different executions of the workflow in which a particular activity is performed correctly in some instances and incorrectly in other instances in different contextual conditions, and the results of the simulations may be analyzed to determine an amount or cost of rework performed in the workflow when the activity is performed incorrectly. Activities with a higher amount or cost of rework (e.g., above a threshold) may be deemed as critical activities that are candidates for cloud service validation, and with a lower amount or cost of rework (e.g., below a threshold) may be deemed as non-critical activities that are not candidates for cloud service validation.

In accordance with aspects of the invention, the cloud services module 240 is configured to determine confidence levels of the cloud services 215a-n that are configured to validate performance of activities in an industrial process. In embodiments, the cloud services 215a-n are external to (e.g., remote from) both the server 210 and the industrial environment 250, and may be called during an industrial process to validate the performance of certain activities included in the industrial process. For example, after the completion of an activity in the workflow of the industrial process, the process control device 220 may call one of the cloud services 215a-n to validate the performance of the activity. The call may include data associated with the performance of the activity, such as data collected from sensors 260 including but not limited to the contextual data described above. In response to receiving the call, the one of the cloud services 215a-n may analyze the data associated with the performance of the activity to determine whether the activity was properly performed. The analysis may include running a digital twin simulation of the activity using the data associated with the performance of the activity and using an AI model to predict that the activity was performed correctly or incorrectly. This indication may be returned to the calling device (e.g., the process control device 220) for validating the performance of the activity. Each of the cloud services 215a-n may be called by plural different end users executing different industrial processes in different industrial environments.

In accordance with aspects of the invention, the cloud services module 240 identifies different respective ones of the cloud services 215a-n that are associated with different respective ones of the activities in the workflow that are candidates for cloud service validation. In one example, a respective one of the cloud services 215a-n is identified for an activity in the workflow based on specifications of the equipment 255 used in the activity. In embodiments, the cloud services module 240 determines a respective confidence level associated with each identified one of the cloud services 215a-n. In embodiments, the cloud services module 240 determines a confidence level associated with one of the cloud services 215a-n based on historical data including: amounts of rework associated with the activity associated with the one of the cloud services 215a-n; and numbers of repeated calls to the one of the cloud services 215a-n. In embodiments, the confidence level associated with a respective one of the cloud services 215a-n is a measure of the cloud service itself, as opposed to a confidence level of an individual prediction made by the cloud service. Various algorithms may be used in determining the confidence level associated with a respective one of the cloud services 215a-n.

In one example, the cloud services module 240 determines the confidence level for a cloud service using an algorithm that is based on: historic data associated with plural instances of predictions made by the cloud service and amounts of rework performed after those predictions; and historic data associated with plural instances of predictions made by the cloud service and numbers of repeated calls associated with a same activity. In this example, the algorithm decreases the confidence level associated with the cloud service based on each historical instance of the cloud service having predicted that an activity was performed correctly when, in actuality, the activity was not performed correctly, and rework of the activity was required. The algorithm may be configured such that the amount of rework affects the amount of decrease of the confidence level. In this example, the algorithm increases the confidence level associated with the cloud service based on each historical instance of the cloud service having predicted that an activity was performed correctly when, in actuality, the activity was performed correctly, and no rework of the activity was required. Still referring to this example, the algorithm decreases the confidence level associated with the cloud service based on each historical instance of the cloud service having repeated calls associated with the same activity from a same process. Repeated calls for the same activity may indicate that the activity was not performed correctly and that the activity is being reworked. As such, the algorithm may decrease the confidence level of a cloud service that predicted correct performance of the activity despite such repeated calls to the cloud service for this activity. The algorithm may be configured such that the number of repeated calls for the same activity affects the amount of decrease of the confidence level. In this example, the algorithm increases the confidence level associated with the cloud service based on each historical instance of the cloud service having predicted that an activity was performed correctly when and there being no repeated calls associated with the same activity from a same process. These examples are not limiting, and other logic may be used in the algorithm for determining a confidence level of a respective one of the cloud services 215a-n.

In accordance with aspects of the invention, the optimization module 245 is configured to optimize usage of the cloud services based on the confidence levels. In embodiments, the optimization module 245 runs an optimization algorithm associated with usage of a respective one of the cloud services 215a-n based on the confidence level determined for the respective one of the cloud services 215a-n. In one example, for a respective one of the one of the cloud services 215a-n that is associated with a respective one of the activities identified as a candidate for cloud service validation, the optimization includes: executing the respective one of the plurality of cloud services following completion of the respective one of the activities based on the confidence level of the respective one of the plurality of cloud services being greater than a threshold; or not executing the respective one of the plurality of cloud services following completion of the respective one of the activities based on the confidence level of the respective one of the plurality of cloud services being less than the threshold. In this example, executing the cloud service may comprise the process control device 220 calling one of the cloud services 215a-n following completion of an activity in the industrial environment 250, wherein the call includes data that is associated with performance of the activity in the from the industrial environment 250, including but not limited to the contextual data described above.

In some embodiments, the cloud services module 240 determines plural different confidence levels for a respective one of the cloud services 215a-n based on different contextual situations. For example, the historic data associated with instances of predictions made by a particular cloud service may include contextual data, and the cloud services module 240 may use clustering to determine different contextual situations for the cloud service based on this context data. The cloud service module 240 may then determine respective confidence levels for the cloud service for each of the different contextual situations, e.g., in the manner described above. In such embodiments, after completing an activity in the industrial environment 250, the optimization module 245 may determine from context data of the industrial environment 250 which of the contextual situations is associated with the activity. The optimization module 245 may then perform the optimization using the particular confidence level determined for the particular contextual situation for the cloud service associated with the activity. In this manner, determining whether to call the cloud service after completion of the activity is based on further based on a current context associated with the activity performed in the industrial environment 250.

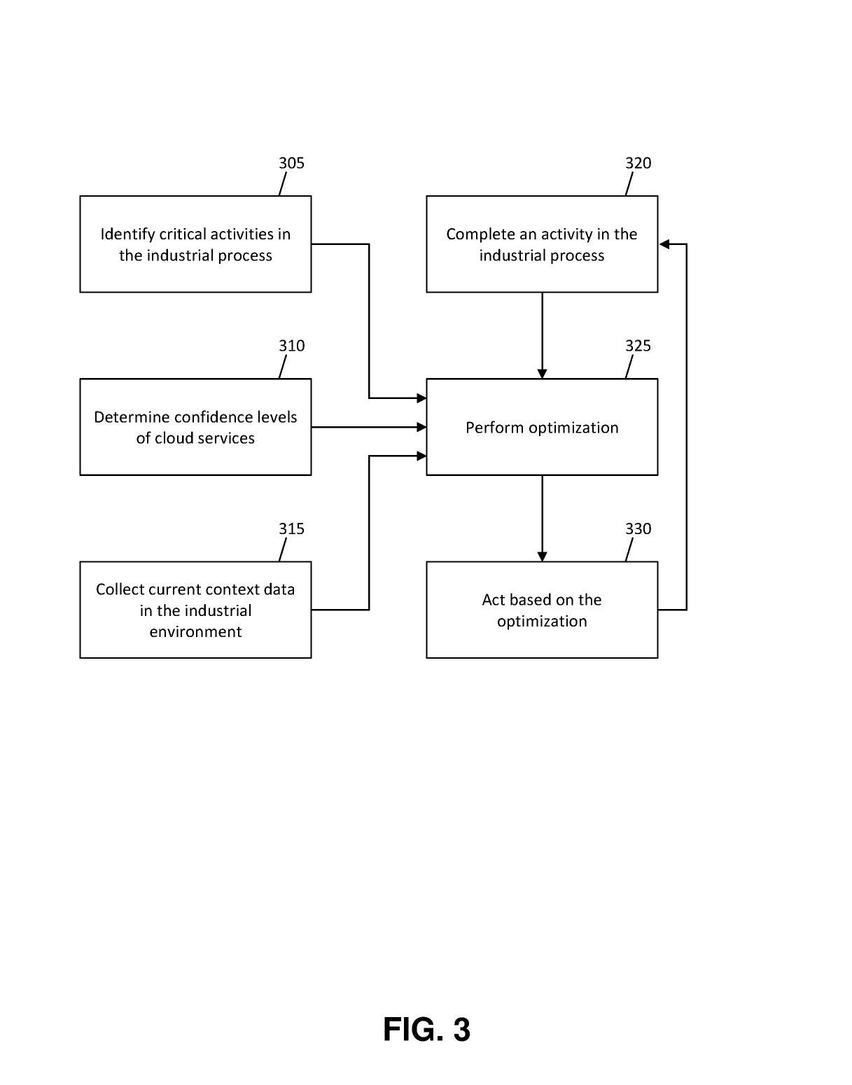

FIG. 3 shows a flowchart of an exemplary method in accordance with aspects of the present invention. Steps of the method (also referred to as operations) may be carried out in the environment of FIG. 2 and are described with reference to elements depicted in FIG. 2.

At step 305 the server 210 identifies critical activities in the workflow. In embodiments, and as described with respect to FIG. 2, this step may comprise analyzing the context data associated with the activity to determine a level or risk based on the activity being performed incorrectly, and rework involved if the is performed incorrectly.

At step 310, the server 210 determines confidence levels for cloud services. In embodiments, and as described with respect to FIG. 2, this step may comprise collecting historical information associated with predictions made by cloud services and determine the confidence level using an algorithm and the historical information.

At step 315, the server 210 collects current context data. In embodiments, and as described with respect to FIG. 2, this step may comprise collecting context data from equipment 255 and sensors 260, the data being associated with the activity being executed in the industrial environment. The sensors 260 may include but are not limited to Internet of Things (IoT) sensors and cameras.

At step 320, an activity is completed in the industrial process in the industrial environment. As described herein, the activity may comprise one or more steps or one or more processes in the workflow.

At step 325, the server 210 performs an optimization of the usage of the cloud services 215a-n for the activity from step 320 and based on information associated with steps 305, 310, and 315. In embodiments, and as described with respect to FIG. 2, this step may comprise performing a cost benefit analysis for the cloud service associated with the activity from step 320. The optimization may comprise determining whether the activity from step 320 is a critical activity from step 305. If the activity is a critical activity, the optimization may comprise determining whether to call the cloud service to validate the activity, this determination being based on the determined confidence levels from step 310 and the current context data from step 315.

At step 330, the server 210 acts based on the optimization of step 325. In embodiments, and as described with respect to FIG. 2, this step may comprise calling or not calling a cloud service to validate the activity of step 320 based on the optimization at step 325. Calling the cloud service may be performed by the process control device 220 or by the server 210 acting on behalf of the process control device 220. After step 330, the process returns to step 320 for completion of a next activity in the industrial process.

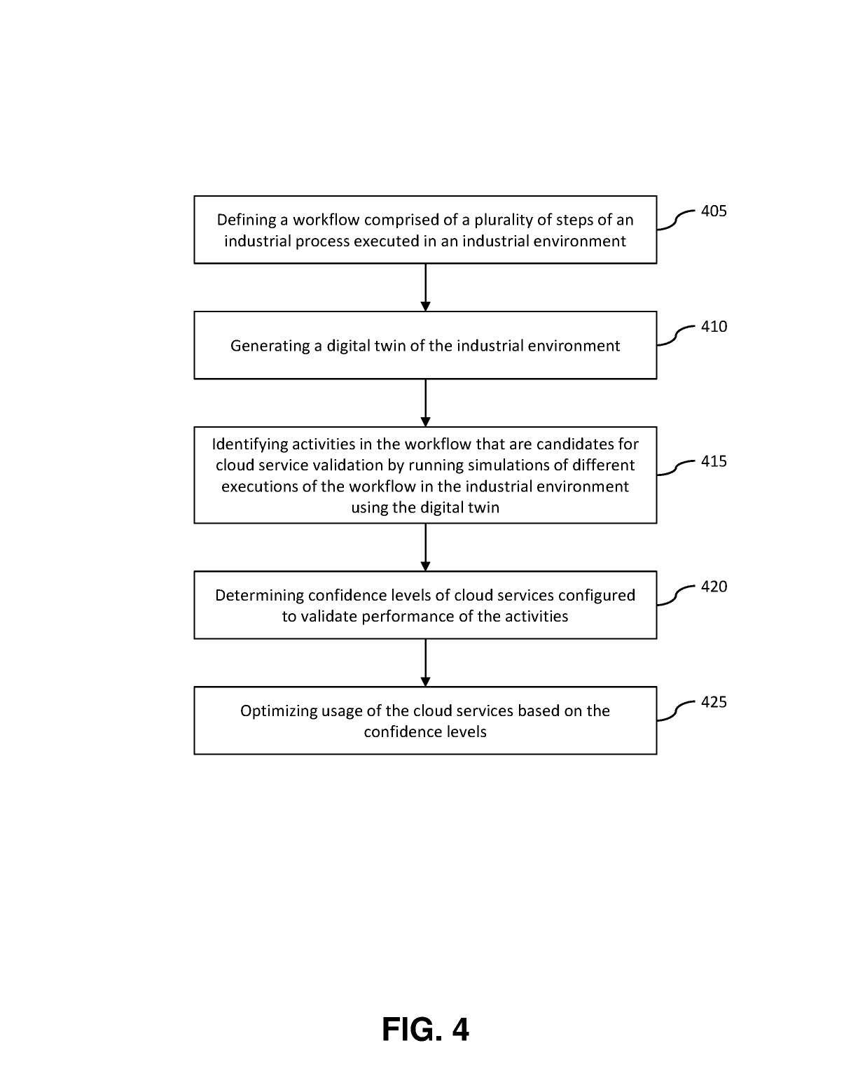

FIG. 4 shows a flowchart of an exemplary method in accordance with aspects of the present invention. Steps of the method (also referred to as operations) may be carried out in the environment of FIG. 2 and are described with reference to elements depicted in FIG. 2. In embodiments, the method comprises: defining a workflow comprised of a plurality of steps of an industrial process executed in an industrial environment (step 405); generating a digital twin of the industrial environment (step 410); identifying activities in the workflow that are candidates for cloud service validation by running simulations of different executions of the workflow in the industrial environment using the digital twin (step 415); determining confidence levels of cloud services configured to validate performance of the activities (step 420); and optimizing usage of the cloud services based on the confidence levels (step 425).

In embodiments of the method, an output of a respective one of the cloud services associated with a respective one of the activities indicates one of: the respective one of the activities was performed correctly; or the respective one of the activities was performed incorrectly.

In embodiments of the method, the optimizing comprises, for each respective one of the activities, performing one of: executing a respective one of the plurality of cloud services associated with the respective one of the activities based on a respective one of the confidence levels of the respective one of the plurality of cloud services being greater than a threshold; or not executing the respective one of the plurality of cloud services associated with the respective one of the activities based on the respective one of the confidence levels level of the respective one of the plurality of cloud services being less than the threshold.

In embodiments of the method, the optimizing is further based on a current context associated with the industrial environment.

In embodiments of the method, the simulations of the different executions of the workflow in the industrial environment are based on different contextual situations.

In embodiments of the method, the confidence levels are determined based on historical data including: amounts of rework associated with respective ones of the activities; and numbers of repeated calls to respective ones of the cloud services.

In embodiments of the method, the industrial environment comprises an industrial floor and the industrial process comprises assembling or disassembling a machine or structure in the industrial floor.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
defining a workflow comprised of a plurality of steps of an industrial process executed in an industrial environment;
generating a digital twin of the industrial environment;
identifying activities in the workflow that are candidates for cloud service validation by running simulations of different executions of the workflow in the industrial environment using the digital twin, wherein each of the activities comprises one or more of the plurality of steps;
determining confidence levels of cloud services configured to validate performance of the activities; and
optimizing usage of the cloud services based on the confidence levels.

2. The method of claim 1, wherein an output of a respective one of the cloud services associated with a respective one of the activities indicates one of:
the respective one of the activities was performed correctly; or
the respective one of the activities was performed incorrectly.

3. The method of claim 1, wherein the optimizing comprises, for each respective one of the activities, performing one of:
executing a respective one of the plurality of cloud services associated with the respective one of the activities based on a respective one of the confidence levels of the respective one of the plurality of cloud services being greater than a threshold; or
not executing the respective one of the plurality of cloud services associated with the respective one of the activities based on the respective one of the confidence levels level of the respective one of the plurality of cloud services being less than the threshold.

4. The method of claim 1, wherein the optimizing is further based on a current context associated with the industrial environment.

5. The method of claim 1, wherein the simulations of the different executions of the workflow in the industrial environment are based on different contextual situations.

6. The method of claim 1, wherein the confidence levels are determined based on historical data including:
amounts of rework associated with respective ones of the activities; and
numbers of repeated calls to respective ones of the cloud services.

7. The method of claim 1, wherein:
the industrial environment comprises an industrial floor; and
the industrial process comprises assembling or disassembling a machine or structure in the industrial floor.

8. A computer program product comprising:
one or more computer-readable storage media; and
program instructions stored on the one or more computer-readable storage media to perform operations comprising:
defining a workflow comprised of a plurality of steps of an industrial process executed in an industrial environment;
generating a digital twin of the industrial environment;
identifying activities in the workflow that are candidates for cloud service validation by running simulations of different executions of the workflow in the industrial environment using the digital twin, wherein each of the activities comprises one or more of the plurality of steps;
determining confidence levels of cloud services configured to validate performance of the activities; and
optimizing usage of the cloud services based on the confidence levels.

9. The computer program product of claim 8, wherein an output of a respective one of the cloud services associated with a respective one of the activities indicates one of:
the respective one of the activities was performed correctly; or
the respective one of the activities was performed incorrectly.

10. The computer program product of claim 8, wherein the optimizing comprises, for each respective one of the activities, performing one of:
executing a respective one of the plurality of cloud services associated with the respective one of the activities based on a respective one of the confidence levels of the respective one of the plurality of cloud services being greater than a threshold; or
not executing the respective one of the plurality of cloud services associated with the respective one of the activities based on the respective one of the confidence levels level of the respective one of the plurality of cloud services being less than the threshold.

11. The computer program product of claim 8, wherein the optimizing is further based on a current context associated with the industrial environment.

12. The computer program product of claim 8, wherein the simulations of the different executions of the workflow in the industrial environment are based on different contextual situations.

13. The computer program product of claim 8, wherein the confidence levels are determined based on historical data including:
amounts of rework associated with respective ones of the activities; and
numbers of repeated calls to respective ones of the cloud services.

14. The computer program product of claim 8, wherein:
the industrial environment comprises an industrial floor; and
the industrial process comprises assembling or disassembling a machine or structure in the industrial floor.

15. A computer system comprising:
a processor set;
one or more computer-readable storage media; and
program instructions stored on the one or more computer-readable storage media to cause the processor set to perform operations comprising:
defining a workflow comprised of a plurality of steps of an industrial process executed in an industrial environment;
generating a digital twin of the industrial environment;
identifying activities in the workflow that are candidates for cloud service validation by running simulations of different executions of the workflow in the industrial environment using the digital twin, wherein each of the activities comprises one or more of the plurality of steps;
determining confidence levels of cloud services configured to validate performance of the activities; and
optimizing usage of the cloud services based on the confidence levels.

16. The computer system of claim 15, wherein an output of a respective one of the cloud services associated with a respective one of the activities indicates one of:
the respective one of the activities was performed correctly; or
the respective one of the activities was performed incorrectly.

17. The computer system of claim 15, wherein the optimizing comprises, for each respective one of the activities, performing one of:
executing a respective one of the plurality of cloud services associated with the respective one of the activities based on a respective one of the confidence levels of the respective one of the plurality of cloud services being greater than a threshold; or
not executing the respective one of the plurality of cloud services associated with the respective one of the activities based on the respective one of the confidence levels level of the respective one of the plurality of cloud services being less than the threshold.

18. The computer system of claim 15, wherein the optimizing is further based on a current context associated with the industrial environment.

19. The computer system of claim 15, wherein the simulations of the different executions of the workflow in the industrial environment are based on different contextual situations.

20. The computer system of claim 15, wherein the confidence levels are determined based on historical data including:
amounts of rework associated with respective ones of the activities; and
numbers of repeated calls to respective ones of the cloud services.
